(19) United States
(12) Patent Application Publication
(10) Pub. No.: US 2007/0088645 A1
(43) Pub. Date: Apr. 19, 2007

(54) System and method of valuation of intellectual property

(76) Inventor: Li Lin, Singapore (SG)

Correspondence Address: Hugh R. Kress;Browning Bushman P.C., 5718 Westheimer, Suite 1800, Houston, TX, 77057, US

(21) Appl. No.: 10/569,015

(22) PCT Filed: Aug. 19, 2004
(86) PCT No.: PCT/SG04/00252

§ 371 Date: Dec. 6, 2006

(30) Foreign Application Priority Data
Aug. 22, 2003 (HK) 03106036.0

(51) Int. Cl. G06Q 40/00

(52) U.S. Cl. 705/36 R

(57) ABSTRACT

Intellectual property Exchange, its website www.IPEXL.com, consists of three separate exchanges, namely, intel-lectual property Stock Exchange, intellectual property Index Exchange and intellectual property Portfolio Exchange. Intellectual property Stock Exchange creates a market, which enables buyers and sellers to efficiently and reliably trade intellectual property stocks and licenses at fair market price. Intellectual property Stock Exchange itself is an ideal valuator for intellectual property assets. Intellectual property Index Exchange trades futures and options of IPEXL indices. In addition, intellectual property units trust and bonds will be marketed in the intellectual property

### SUMMARY OF INVENTION

According to one broad aspect, the present invention provides a method of valuation of intellectual property assets. The method includes, in one aspect, the formation of an “intellectual property stock exchange” with the steps as mentioned below. Intellectual property assets are divided into a predetermined number of intellectual property stocks. An intellectual property stock represents a claim on its proportional share of the intellectual property assets. A license of the intellectual property assets could be granted to a buyer, who aggregates to a pre-set percentage of the intellectual property stocks. The information of the intellectual property assets is stored in a server computer, which accessed by a plurality of client computers.

The server computer receives orders, which are request from a plurality of client computers for willing buyers and sellers to buy or sell a specified amount of a particular intellectual property stocks at a specified price. The server computer executes orders of the intellectual property stocks. The value of the intellectual property assets is calculated using the executed price in the server computer.

In one preferred implementation, the present invention provides a further method of valuation of intellectual property by receiving at least a second order of the intellectual property stocks in the server computer via the client computers from a second buyer and a second seller. A second order of said intellectual property stocks is then executed in the server computer. The difference of value of the intellectual property asset between the first executed price and second executed price is calculated and will be reported to the intellectual property derivative exchange.

In another broad aspect, the present invention provides a system for valuation of intellectual property assets by using a server computer and at least one client computer. The server computer includes means for dividing the intellectual property asset into a predetermined number of intellectual property stocks, deciding a pre-set percentage of the intellectual property stocks for a license, storing the information of the intellectual property assets, receiving orders from client computers, executing orders of the intellectual property stocks, calculating the value of the intellectual property assets based on executed price of each intellectual property stock and communications means for exchanging secured information with client computers. The client computer is linked to the server computer and is capable of communication therewith. The client computer includes means for receiving and storing relevant information of the intellectual property assets, receiving orders from buyers and sellers, forwarding orders to the server computer.

In one preferred implementation, the means for storing and retrieving information and the means for storing and receiving information is memory space in the server computer and the client computer respectively. In another preferred implementation, the communications means to exchange secured information with other computers contains a physical connection and operating system to operate physical connection between the server computer and the client computer. In another preferred implementation, the means for receiving information from buyers and sellers is a client program in the client computer.

### BRIEF DESCRIPTION OF FIGURES

FIG. 1 is a block diagram of a computer system in accordance with an embodiment of the invention.

FIG. 2 is a block diagram of the software & hardware structure of the server computer of FIG. 1

FIG. 3 is a block diagram of the software & hardware structure of the client computers of FIG. 1.

FIG. 4 is a flow diagram of the intellectual property Stock Exchange operation.

FIG. 5 illustrates patent information table displayed by the client program of FIG. 3 during operation of the computer system of FIG. 1.

FIG. 6 is a spread table for intellectual property stocks trade in the intellectual property Exchange

FIG. 7 is a flow diagram of the intellectual property Index Exchange operation.

FIG. 8 is a flow diagram of the intellectual property Portfolio Exchange operation.

FIG. 9 is a table of Market Participants Qualifications in the intellectual property Exchange

### DETAILED DESCRIPTION

As used herein, “intellectual property assets” offered for trading may include but not limited to: patents (including utility, design and plant with a status of pending or granted), trademarks (including service marks, word marks, design marks and logos), copyrights and domain names.

The present invention creates an innovative intellectual property Stock Exchange which provides an ideal valuation mechanism for the intellectual property assets. The present invention further creates an intellectual property Index Exchange and an intellectual property Portfolio Exchange for financial derivative market.

The broad valuation of company assets comprises two major assets namely: (1) tangible assets and (2) intellectual property assets. We denote Vc as the value of company assets, Vt as the value of tangible assets and Vip as the value of intellectual property assets.
Vc=Vt+Vip (1)

Stock market has worked pretty well in most of the countries in the world. It is proven that stock market is powerful financial venue to raise find for companies. When a company raises fund in stock market, it will practise following five steps:
1. Assessing the value of the company assets Vc;
2. Dividing the company assets into company stocks;
3. Deciding the percentage of the company stocks to be sold;
4. Listing company stocks with an initial public offering (IPO) price; and
5. Trading company stocks in the stock market.

Stock market is a powerful valuation mechanism to extract the market value of the companies. The stock market has demonstrated that it posses self-correction, self-calibration and self-adjusting valuation mechanism. There are two types of companies:

Type A: Companies IPO prices are quite close to the actual trading prices;

Type B: Companies IPO prices are far below or much higher comparing with the actual trading prices.

We notice that companies with majority portions of tangible assets more or less belong to the Type A category with certain accuracy. This means that the valuators cumulate enough experience to value tangible assets. However, companies with majority portions of intellectual property assets fall into the Type B category most of the cases. Intellectual property assets take precedence over tangible assets in both their contribution and valuation recently.
Vip>Vt (2)

This scenario shows that the indicated IPO prices and the valuation methods of intellectual property assets are really questionable. Intellectual property assets valuation is “an imprecise are” unless you have a willing buyer or a proven infringer. The existing valuation methods become inaccurate if not invalid when apply them to value pure intellectual property assets. We face a serious problem.

In life, the most serious problem basically cannot be solved directly. It might be there forever. However, we can make it less important to us. In fact, most of inventors (or political leaders) are not solving problems directly, instead, they create new concept to dilute (or divert) the importance of the existing problems. For example, Dr. Claude Shannon, the creator of communication, published his landmark A Mathematical Theory of Communication in 1948. His theory is arguably one of the greatest intellectual achievements of the twentieth century. It is truly visionary thinking.

One of his most brilliant insights was the separation of problems like these, where the encoder must take both the source and channel into account, into two coding problems. He showed that with no loss of generality one can study the source and channel separately. Solution of the source and channel problems leads immediately to the solution to the original joint source-channel problem. He greatly simplified the coding problems.

Similarly, the present invention applies this technique to company assets valuation procedures. We now separate a company's assets Vc into Vt and Vip, and we value them independently. In other words, when we value company assets, we separately value its tangible assets Vt and intellectual property assets Vip.

Imagine a company with only intellectual property assets and without any tangible assets trades in stock market.
Vip=Vc where Vt=0 (3)
It is equivalent to intellectual property assets being divided into intellectual property stocks trade in stock market. We define this particular stock market trades only intellectual property stocks, and name it an intellectual property Stock Exchange. Indeed, this intellectual property Stock Exchange is a special stock market, and it only trades intellectual property stocks. Hence, the intellectual property Stock Exchange inherits stock market powerfull valuation mechanism; it is valid and valuable to apply this mechanism to value intellectual property assets in the knowledge-based economy.

Since the existing valuation methods of intellectual property assets cannot provide a good indicated IPO price; at the same time, intellectual property Stock Exchange itself is so powerful valuation mechanism that can correct any mistaken and arbitrary IPO price. It is really NOT necessary to assess the value of intellectual property assets before trading intellectual property stocks in the intellectual property Stock Exchange. Therefore, we can remove this costly and time consuming procedure. Since we can assign an arbitrary IPO price to trade in the intellectual property Stock Exchange, it is also NOT necessary to have this procedure. To simplify the licensing process, the intellectual property Stock Exchange could grant a license to those who have aggregated a pre-set percentage of the intellectual property stocks. This is a unique feature of the intellectual property Stock exchange.

When a proprietor of intellectual property assets raises fund in the intellectual property Stock Exchange, it will practise following three steps:
1. Dividing the intellectual property assets into intellectual property stocks;
2. Deciding the percentage of the intellectual property stocks for granting a license;
3. Trading intellectual property stocks in the intellectual property Stock Exchange.

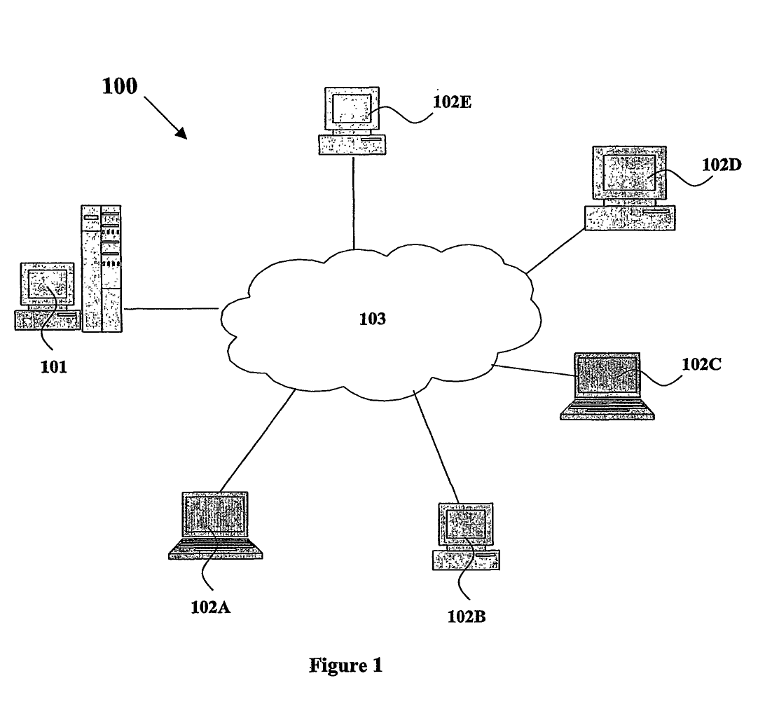

As used herein a computer system to illustrate and implement the present invention. Referring now to FIG. 1, a computer system 100 may include but not limited to a server computer system 101 and a plurality of distributed client computers 102i (where i=A, B, C, D, E, etc.) connected via a network 103 including but not limited to internet and proprietary network.

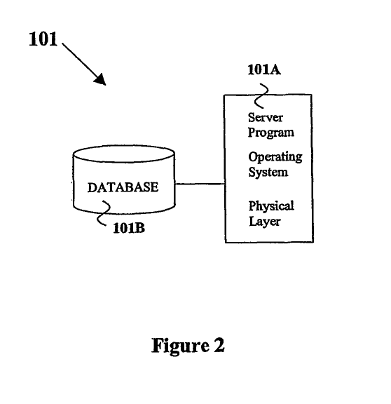

FIG. 2. illustrates the software and hardware structure of server computer system 101. During operation of computer system 100, a server program is executed on top of an operating system, which controls physical layer in server computer system 101. Physical layer provides a physical connection to network 103. The server program stores and retrieves information in database 101B. The server program receives orders, executes orders, and calculates the value of the intellectual property assets.

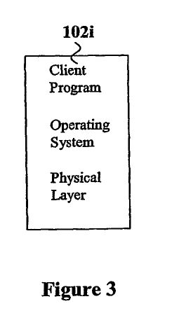

FIG. 3 illustrates the software and hardware structure of a client computer 102i. During operation of computer system 100, a client program is executed on top of an operating system, which controls physical layer in client computer 102i. Physical layer provides a physical connection to network 103. Buyers and sellers access the intellectual property Exchange and place orders via client program in client computers 102i. The client program in client computer 102i communicates with server program in server computer 101A via network 103. The client program forwards orders to server program.

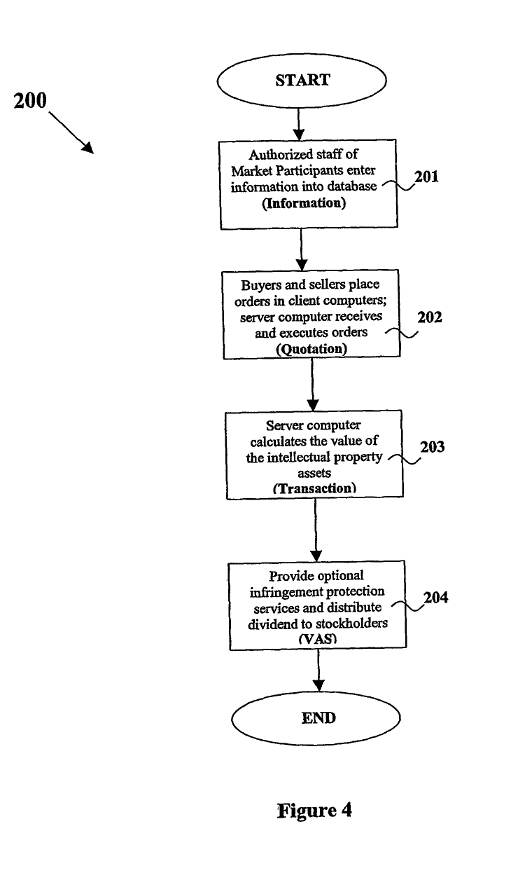

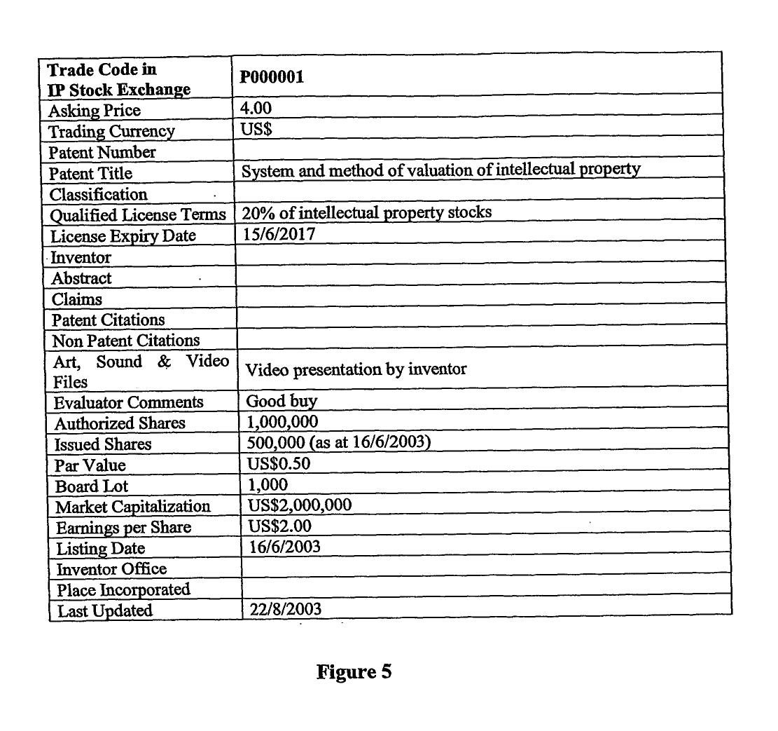

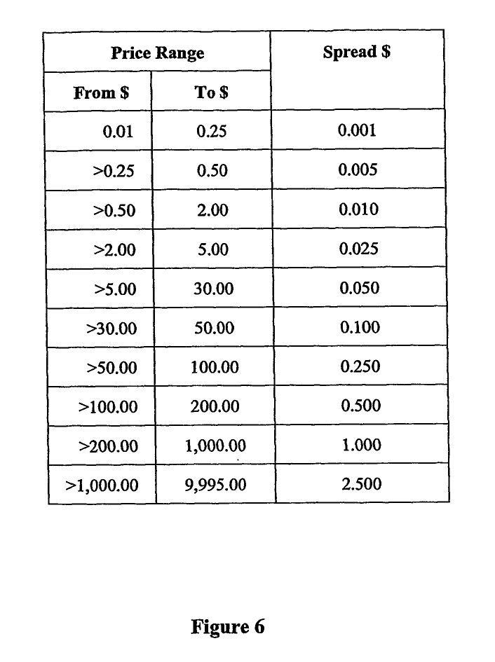

FIG. 4 is a flow diagram of the intellectual property Stock Exchange operation 200, in accordance to an embodiment of the invention. To illustrate and standardize transactional rule of the intellectual property Stock Exchange, intellectual property assets could be divided into a predetermined number, such as 1,000,000 of stocks. The larger the predetermined number, the more accurate the stock reflects its market value. The intellectual property Stock Exchange may adopt but is not limited to the International Patent Classification (IPC) latest edition which consists of: 8 Sections, 120 Classes, 628 Subclasses, and almost 69,000 Groups. A patent or a group/subclass of patents having a value of $100 million will be quoted as $100 per stock. Board lot size could be 1,000 stocks. All subsequent bid and ask transactions are in increments of 1,000 stocks. A sample of patent information stored in database 101B is listed in FIG. 5. Intellectual property stocks trade in accordance with the scale of spreads set out in the spread table stored in database 101B in FIG. 6.

In stage 201 of Information step, authorized staff of Market Participants uses client program in client computers 102i to create intellectual property portfolio, and enters information includes but not limited to (1) the predetermined number; (2) the pre-set percentage; and (3) the proprietor of the intellectual property assets, into database 101B via network 103. In stage 202 of Quotation step, buyers and sellers are able to place orders of intellectual property stocks by using client program in client computers 102i, and the orders are received by the server program in server computer 101OA via network 103. The server program in the server computer 101A executes orders of the intellectual property stocks. In stage 203 of Transaction step, the server program in the server computer 101A calculates the value of intellectual property assets by multiplying the executed price of each intellectual property stock with the predetermined number of the intellectual property assets. The server program transfers the executed intellectual property stocks to successful buyers via client computers 102i. The server program grants a license of the intellectual property assets to a qualified buyer via client computers 102i. In stage 204 of value-added service (VAS) step, the intellectual property Stock Exchange provides an optional infringement protection, and the recovery value of such infringement could be contributed as a form of dividend to the stockholders of the intellectual property stocks. The dividends could be distributed proportionally according to the information of the stockholders stored in the server computer database 101B.

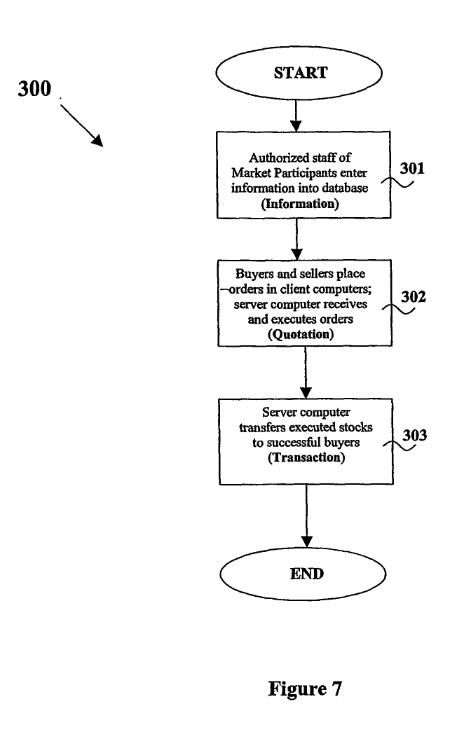

FIG. 7 is a flow diagram of the intellectual property Index Exchange operation 300, in accordance to an embodiment of the invention. The server program in the server computer 101A calculates the indices according to the intellectual property Stock Exchange. In stage 301 of Information step, authorized staff of Market Participants enters information of the futures and options of the indices into database 101B via network 103. In stage 302 of Quotation step, buyers and sellers are able to place call or put orders of futures and options of selected indices by using client program in client computers 102i, and the orders are received by the server program in server computer 101A via network 103. The server program in the server computer 101A executes orders of futures and options of selected indices. In stage 303 of Transaction step, the server program transfers executed stocks of futures and options of selected indices to successful buyers via client computers 102i.

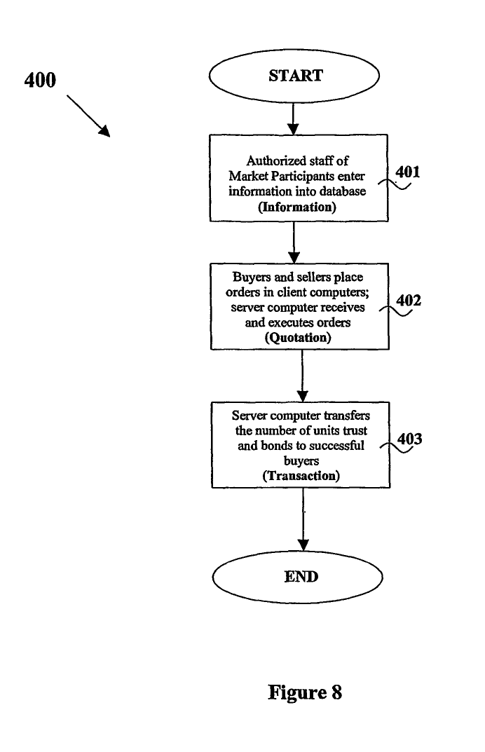

FIG. 8 is a flow diagram of the intellectual property Portfolio Exchange operation 400, in accordance to an embodiment of the invention. The server program in the server computer 101A calculates the price of the units trust and bonds according to the intellectual property Stock Exchange. In stage 401 of formation step, authorized staff of Market Participants enters information of units trust and bonds into database 101B via network 103. Each unit trust or bond is bundled intellectual. property assets. In stage 402 of Quotation step, buyers and sellers are able to place orders of units trust and bonds by using client program in client computers 102i and the orders are received by the server program in server computer 101A via network 103. The server program in the server computer 101A executes orders of units trust and bonds via network 103. In stage 403 of Transaction step, the server program transfers the number of units trust and bonds to successful buyers via client computers 102i.

The intellectual property Exchange website: www.ipexl.com supports three separate exchanges, namely intellectual property Stock Exchange, intellectual property Index Exchange, and intellectual property Portfolio Exchange.

The intellectual property Stock Exchange provides a user-friendly interface to search a comprehensive listing of available intellectual property stocks. The actual price of intellectual property stocks, quotes by buyers and sellers in the intellectual property Stock Exchange.

The intellectual property indices are developed to measure performance of the intellectual property Stock Exchange. The indices comprise of IPEXL Index and IPEXL [Section_Name or Class_Name] Indices. They may be market-value weighted or price-weighted indices. The purpose of the indices creation is to allow a hedging mechanism for investors of intellectual property. The intellectual property Index Exchange provides a user-friendly interface to search a comprehensive listing of available futures and options of the indices.

The intellectual property Portfolio Exchange allows for the buying and selling of small pieces of bundled intellectual property assets. Intellectual property holders may bundle intellectual property assets, securitize them into units trust or bonds, and lists these units trust or bonds on the intellectual property Portfolio Exchange. For example, universities and research institutions may be the most likely candidates to offer units trust or bonds as they have large quantities of related patents that would lend well to an intellectual property units trust or bonds.

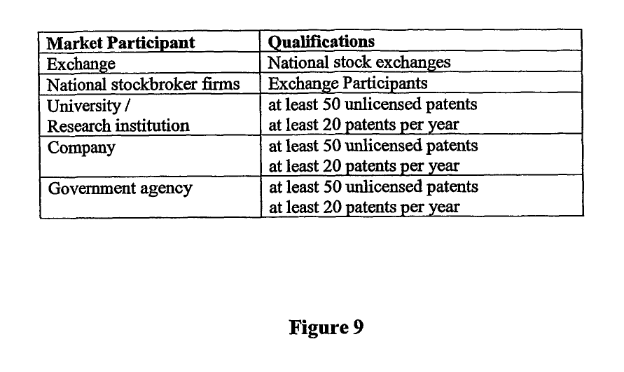

The present invention provides an intellectual property market for high integrity Market Participants. These Market Participants must meet certain quality standards as shown in FIG. 9. Principal Participants are buyers and sellers of intellectual property assets. Intermediary Participants are those acting on behalf of a principal buyer or seller. Government agencies, universities & research institutions, and companies not meeting the Market Participants criteria or not wishing to participate directly, may buy or sell intellectual property assets through Intermediary Participants. Exchange Reserve Fund can be established whereby Market Participants contributed fixed sums of monies to the intellectual property Exchange as reserve in the event of litigations. Each member of Market Participants is in turn self-insured against litigations.

Security is always the first priority for intellectual property Exchange. Intellectual property Exchange uses the highest level of security available, to protect the confidentiality of its users'account information in database 101B and for all transactions. Intellectual property Exchange uses the strongest encryption technology. Any data you send will be scrambled into an unrecognized form before it is transmitted, and only intellectual property Exchange has the special key to decode it. To increase security, intellectual property Exchange uses digital certificates to help authenticate users. Every time when you log on, intellectual property Exchange will verify your username and password to prevent unauthorized access.

Intellectual property assets like tangible assets are assets that may use, trade, mortgage and license exclusively or partially. Intellectual property assets are divisional to intellectual property stocks. When intellectual property assets were divided into a form of intellectual property stocks to trade, it is conceivable that it greatly dilutes the risk of valuation and trading of intellectual property assets for buyers and sellers. Without knowing the value of intellectual property assets, the present invention allows trading of intellectual property stocks to proceed. The intellectual property Stock Exchange provides a market to value intellectual property assets cum intellectual property stocks transaction. It provides timely and precise market price of intellectual property assets. The market price was feedback among buyers and sellers automatically.

The intellectual property Stock Exchange business model is grounded on the following innovative concepts:
1. Intellectual property Stock Exchange is an ideal valuator of intellectual property: without assessing the value of intellectual property assets, intellectual property assets will be divided into a predetermined number of intellectual property stocks to trade in the intellectual property Stock Exchange.
2. Simplified intellectual property Licensing Mechanism: when aggregating to a pre-set percentage of the intellectual property stocks, a buyer could be granted a license upon request in the intellectual property Stock Exchange.

The inventor views the intellectual property Stock Exchange as a communication system with feedback loop. We find that buyers as transmitters, sellers as receivers; the intellectual property Stock Exchange as communication channel. With market feedback function (bid and ask), the buyers and sellers dynamically and adaptively match market condition, which choose the best route to realize intellectual property market value and fulfill the best interest for the buyers and sellers. The following references are relevant to the present invention:
C. E. Shannon, “A mathematical Theory of Communication, “The Bell System Technical Journal, Vol. 27, pp379-423, 623-656, July, October, 1948.
Robert H. Deng and Michael L. Lin, “A type I hybrid ARQ system with adaptive code rates,” IEEE Trans. Commun., Vol. COM-43, no. 2/3/4, pp. 733-737, February 1995.
“The New Emphasis on patent value: Opportunities and challenges,” presented by International Intellectual Property Institute on 24 Jul. 2002.

While the present invention has been described using the aforementioned figures and the specific examples, it is understood that these are examples only and should not be taken as limitation to the present invention. It should also be understood that intellectual property Exchange only represents one embodiment of the present invention and the same principle of the present invention can also apply to other embodiments and configurations.

1. A method of valuation of intellectual property assets of a proprietor comprising:
a) dividing intellectual property assets into a predetermined number of intellectual property stocks;
b) deciding a pre-set percentage of said intellectual property stocks for licensing;
c) storing the information of said intellectual property assets in a server computer;
d) receiving orders of said intellectual property stocks in said server computer via a plurality of client computers from a plurality of buyers and sellers;
e) executing orders of said intellectual property stocks in said server computer; and
f) calculating the value of the intellectual property assets by multiplying the executed price with the predetermined number in said server computer.

2. A method according to claim 1, further comprising:
a) receiving at least a second order of said intellectual property stocks in said server computer via said client computers from a second buyer and a second seller;
b) executing a second order of said intellectual property stocks in said server computer;
c) calculating the difference of value of said intellectual property assets between said first executed price and second executed price; and
d) reporting said difference of value to a derivative exchange.

3. A system for valuation of intellectual property assets of a proprietor comprising:
a) a server computer comprising:
i) means for dividing intellectual property assets into a predetermined number of intellectual property stocks;
ii) means for deciding a pre-set percentage of said intellectual property stocks for licensing;
iii) means for storing and retrieving information of said intellectual property assets;
iv) means for receiving orders from a plurality of client computers;
v) means for executing orders of said intellectual property stocks;
vi) means for calculating the value of said intellectual property assets by multiplying the executed price with the predetermined number in said server computer; and
vii)communication means to exchange secured information with said client computers.
b) at least one client computer, operably linked to said server computer and capable of communication therewith, said client computer comprising:
i) means for receiving and storing information of said intellectual property assets;
ii) means for receiving orders from buyers and sellers;
iii) means for forwarding said orders to said server computer;

4. A system according to claim 3 wherein said means for storing and retrieving information and means for storing and receiving information is memory space in said server computer and said client computer respectively.

5. A system according to claim 3 wherein said communications means to exchange secured information with said client computers comprises a physical connection and operating system to operate said physical connection between said server computer and said client computer.

6. A system according to claim 3 wherein said means for receiving information of said intellectual property assets is a client program in said client computers.

7. A system of operating an intellectual property index exchange comprising:
a) a server computer comprising:
i) means for storing and retrieving information of indices;
ii) means for receiving orders from a plurality of client computers;
iii) means for executing orders of futures and options of indices; and
iv) communication means to exchange secured information with said client computers.
b) at least one client computer; operably linked to said server computer and capable of communication therewith, said client computer comprising:
i) means for storing and receiving information of said indices;
ii) means for receiving orders from buyers and sellers;
iii) means for forwarding said orders to said server computer; and

8. A system according to claim 7 wherein said means for storing and retrieving information and means for storing and receiving information is memory space in said server computer and said client computer respectively.

9. A system according to claim 7 wherein said communications means to exchange secured information with said client computers comprises a physical connection and operating system to operate said physical connection between said server computer and said client computer.

10. A system according to claim 7 wherein said means for receiving information of said intellectual property assets is a client program in said client computer.

11. A system of operating an intellectual property portfolio exchange comprising:
a) a server computer comprising:
i) means for storing and retrieving information of intellectual property units trust and bonds;
ii) means for entering data of units trust and bonds;
iii) means for receiving orders from a plurality of client computers;
iv) means for executing orders of unit trust and bond; and
v) communication means to exchange secured information with said client computers.
b) at least one client computer; operably linked to said server computer and capable of communication therewith, said client computer comprising:
i) means for storing and receiving information of said units trust and bonds;
ii) means for receiving orders from buyers and sellers;
iii) means for forwarding said orders to said server computer; and

12. A system according to claim 11 wherein said means for storing and retrieving information and means for storing and receiving information is memory space in said server computer and said client computer respectively.

13. A system according to claim 11 wherein said communications means to exchange secured information with said client computers comprises a physical connection and operating system to operate said physical connection between said server computer and said client computer.

14. A system according to claim 11 wherein said means for receiving information of said intellectual property asset is a client program in said client computer.
